(19) United States
(12) Patent Application Publication
(10) Pub. No.: US 2008/0144885 A1
(43) Pub. Date: Jun. 19, 2008

(54) Threat Detection Based on Radiation Contrast

(76) Inventors: Mark Zucherman, Thousand Oaks, CA (US); Sarath Gunapala, Stevenson Ranch, CA (US); Sumith Bandara, Stevenson Ranch, CA (US); Don Rafel, South Pasadena (CA)

Correspondence Address: MINTZ, LEVIN, COHN, FERRIS, GLOVSKY AND POPEO, P.C;ATTN: PATENT INTAKE CUSTOMER NO. 64046, ONE FINANCIAL CENTER, BOSTON, MA, 02111, US

(21) Appl. No.: 11/873,276

(22) Filed: Oct. 16, 2007

Related U.S. Application Data
(60) Provisional application No. 60/852,090, filed on Oct. 16, 2006.

(51) Int. Cl. G06K 9/00

(52) U.S. Cl. 382/103

(57) ABSTRACT

Methods and apparatus, including computer program products, for threat detection based on radiation contrast. In general, an image from a device having a sensitivity to infrared radiation having a wavelength between three and fifteen micrometers may be received, images features from the image may be extracted, a classification may be generated of the image features from multiple classifications where the classifications include threats, and data characterizing the classification of the image features may be displayed. The device may operate at a standoff distance of five to one hundred meters. Displaying data characterizing the classification of the image features may include displaying an identification of a person carrying a threat.

### CROSS REFERENCE TO RELATED APPLICATIONS

This application claims the benefit of priority of U.S. patent application entitled “AUTOMATED THREAT DETECTION SYSTEM (ATDS) BASED ON THERMAL GRADIENTS AND EDGE DETECTION”, filed Oct. 16, 2006, Application Ser. No. 60/852,090, the contents of which are hereby fully incorporated by reference.

### BACKGROUND

The present disclosure relates to data processing by digital computer, and more particularly to threat detection based on radiation contrast, thermal gradient detection, and classification.

In public places, such as public walking space outside of an airport, people may be allowed to move about the public places without being checked by a security mechanism or technique. For example, while a person may be subject to metal detectors, explosive detectors, and pat-down searches while passing a security checkpoint of an airport to enter an area including boarding gates, in a public sidewalk outside of the airport or near ticketing counters, security techniques, mechanisms, or both may be limited to video camera surveillance. Detecting threats in some public places may be difficult due to limited interaction with individuals.

### SUMMARY

The subject matter disclosed herein provides methods and apparatus, including computer program products, that implement techniques related to threat detection based on radiation contrast.

In one, general aspect, an image is received from a device including a focal plane array having a sensitivity to radiation having a wavelength from 3 to 15 micrometers, where the image is of a zone of interest in which human traffic is present and the human traffic is at a distance of 5 to 100 meters from the device. The image is processed by applying one or more image processing techniques including gradient image processing for edge detection based on discontinuities in thermal gradients. Features of the image in which the human traffic is present are extracted based on infrared radiation contrast associated with a human in the human traffic. Additional extracting includes detecting edges being a result of thermal gradient discontinuities, and decomposing at least some of the edges into image features representing spatial objects in an image processing environment, where the spatial objects include line segments and shapes and the image features are represented by one or more data structures. A classification of the image features from a knowledge base populated with classifications of objects of interest being observed based on known concealed objects on a human is generated. The classification is generated by a rule processing engine to process the image features, where the classifications include threats and are generated by extracting features of images from the observed, concealed objects on the human to generate rules for the classifications. Data characterizing the classification of the image features being associated with the human is displayed, where the data characterizes a threat if the classification can be compared or associated with any of the known or previously classified or characterized threats.

In a related aspect, an image from a device including a focal plane array having a sensitivity to radiation having a wavelength from 3 to 15 micrometers is received, features of the image are extracted, a classification of the image features from a knowledge base populated with classifications of objects of interest being observed, concealed objects on a human is generated, and data characterizing the classification of the image features is displayed. Extracting features includes detecting edges being a result of infrared radiation contrast and decomposing at least some of the edges into image features representing spatial objects in an image processing environment. The classification is generated by a rule processing engine to process the image features, where the classifications include threats. The data that is displayed characterizes a threat if the classification is one of the threats.

In a related aspect, an image from a device including a long or mid wavelength infrared (LWIR or MWIR) digital camera is received, features of the image are extracted, a reasoning processing engine is caused to process the image features to generate a classification of the image features from multiple classifications, and data characterizing the classification of the image features is displayed. The extracting includes detecting edges, where each of the edges is a gradient or discontinuity of thermal infrared radiation, and decomposing at least some of the edges into image features representing spatial objects in an image processing environment. The classifications include threats.

In a related aspect, an image from a device including a long or mid wavelength infrared digital camera is received, image features from the image are extracted, a classification is generated of the image features from multiple classifications where the classifications include treats, and data characterizing the classification of the image features is displayed.

The subject matter may be implemented as, for example, computer program products (e.g., as source code or compiled code), computer-implemented methods, and systems.

Variations may include one or more of the following features.

Extracting features of an image may include generating metadata of the image features. Generating a classification may include a reasoning or rule processing engine to process the metadata of the image features. Causing a reasoning process engine to process image features may include causing the reasoning process engine to process the metadata of the image features.

A reasoning process engine may be a rule processing engine, inference engine, or both.

A device having a focal plane array may be one of a quantum well infrared photodetector (QWIP) or an indium antimonide (InSb) detector. A device having a focal plane array may be a long wavelength digital camera having sensitivity to radiation emitted between 3 and 15 micrometers. In some implementations, image data may be received from multiple infrared cameras, including a combination of medium and long wavelength infrared radiation cameras. An infrared camera used to generate image data from which image features are extracted may be a dual-band infrared camera that detects both medium and long wavelength infrared radiation.

Receiving images, extracting image features, classifying extracted image features, and displaying data characterizing classifications may be performed in approximately or near real time, including the near-real time image processing, threat detection, and classification. For example, as a result of the classifying being performed by a high-performance reasoning engine which may be capable of processing inference rules or a knowledge base representation logic in near real-time on desktop class computer processors. For example, a high-performance reasoning engine may be capable of processing over one billion rules per second on desktop class computer processors.

Image features or spatial objects may include line segments, shapes, and connected regions.

Extracting features of an image may include extracting features from an image of one or more humans. Threats may include threats carried by humans.

Features of an image may be at a distance of 5 to 100 meters from a long or mid wavelength digital camera.

The subject matter described herein can be implemented to realize one or more of the following advantages. Medium wavelength infrared cameras, long wavelength infrared cameras, or both may be employed to detect concealed objects being carried or worn by individuals in a public place. Threatening individuals may be detected at standoff distances greater than the capabilities of other detection systems. An effective standoff distance between the cameras and a zone of interest being scanned for possible threats may be sufficiently large to enable observation without being in harm's way. For example, a long or mid wavelength infrared camera may be set up with a sufficient optical element for focusing on individuals from around five to one hundred meters and the camera may have sufficient sensitivity to allow for observation of the zone of interest from that distance. A medium or long wavelength infrared camera may also be of sufficient sensitivity to identify concealed objects under natural and synthetic fibers of a normal weight, which may include light jackets, and may operate in various environmental conditions, such as direct sun, shade, high contrast lighting, and the like.

Detecting objects from infrared radiation may provide a variety of information for a user, which may include a classification (e.g., type or category) of an object, a threat level an object presents (e.g., a classification of threat levels based on no threat, possible threat, and threat; a ranking of threats; or both), a location of an object (e.g., a person on which an object exists, a location on a person, and the like), and the like. Minimum operator training may be required as threats may be identified to an operator by overlaying detected edges from infrared images onto optical, human-visible light images.

A cost savings may be realized using an expert system or inference engine as compared to a traditional software system architecture that needs to be ubiquitously updated each time a new threat characteristic has been identified (e.g., based upon field trials and updated threat categories, system capabilities can be added and removed easily by independently updating a knowledge base or updating capabilities of an expert system, as only one or the other may need updating). System distribution and deployment may also be improved because there may be one basic application code set to maintain for a system using an independent knowledge base for objects of interest and the overall expert system.

Details of one or more implementations are set forth in the accompanying drawings and in the description below. Further features, aspects, and advantages will become apparent from the description, the drawings, and the claims.

### BRIEF DESCRIPTION OF THE DRAWINGS

FIG. 1 is a diagram illustrating transmission of infrared radiation from human skin, a concealed object, and clothing.

FIG. 2 is a block diagram illustrating a process of adding objects of interest into a knowledge base of objects of interest based on extracted image features.

FIG. 3 is a series of illustrations depicting a process of extracting image features from an image.

FIG. 4 is a series of illustrations depicting a process of detecting objects of interest from extracted image features.

FIG. 5 is a diagram of a system and process to acquire or capture images and to detect objects of interest from images.

FIG. 6 is a block diagram of a system to acquire images and detect objects of interest from images using automated reasoning.

FIG. 7 is a flowchart illustrating a process of generating a collection of classified image features.

FIGS. 8A-8D are a series of illustrations depicting user interfaces that may be used to generate detection reasoning rules.

FIG. 9 is a block diagram of a system to generate source code for detection rules.

Like reference numbers and designations in the various drawings indicate like elements.

### DETAILED DESCRIPTION

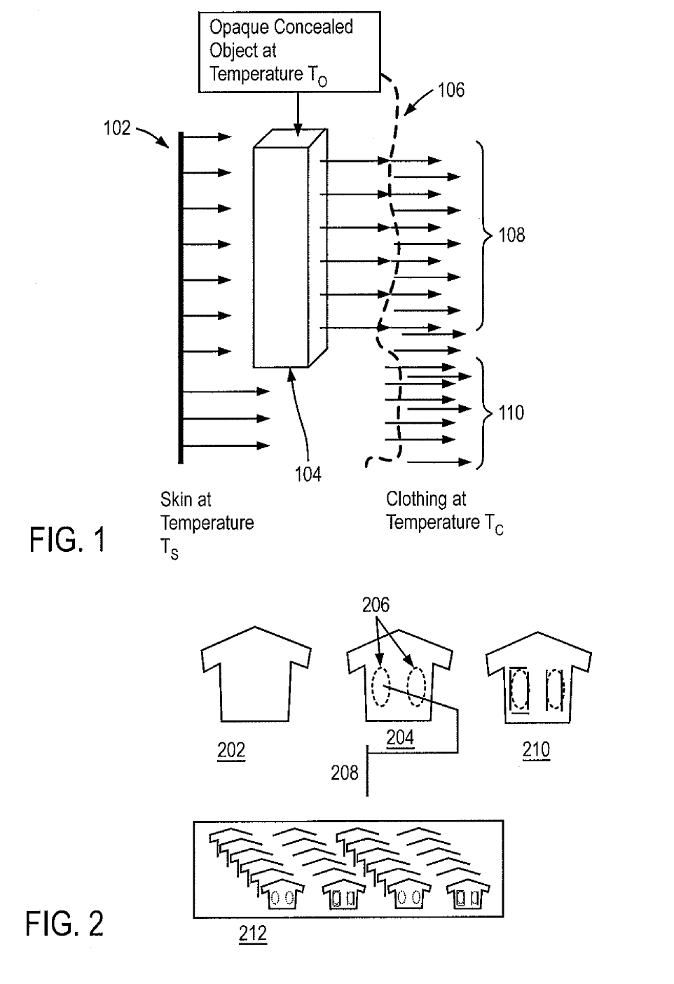

In general, throughout FIGS. 1-9, objects of interest may be detected from an image. Threat detection techniques, mechanisms, or both may determine whether image features include an object of interest and whether a detected object of interest is a threat. Images features that are extracted from an image may include line segments, shapes (including geometric and non-geometric shapes), and connected regions (regions, shapes, or both that share common boundaries or orientations). Properties of image features may include orientation of line segments, shapes, and connected regions, including their rotation and adjacency to other features; a size of an image feature; and the like. Although the above types of image features are discussed throughout the description, other types of primitives may be used as image features from which objects of interest, including threats, may be detected.

FIG. 1 is a diagram illustrating transmission of infrared radiation from human skin 102, a concealed object 104, and clothing 106. Each of the human skin 102, concealed object 104, and clothing 106 may have a different temperature and a different emissivity of transmitted radiation, both of which may affect radiation contrast. In general, based on radiation contrast (which may include radiation or detected thermal gradients or discontinuities), edges of the concealed object 104 may be detected.

Radiation contrast may be determined based differences of observed radiation, which may be a result of differences of surface temperature, sum of irradiance of from surface temperature, emissivity of materials, and transmission properties of objects, such as clothing 106. For example, the skin 102 may have an irradiance that contributes to the concealed object 104, if the concealed object 104 is a semi-transmissive object, and the sum of the irradiance of the concealed object 104 and the partially transmitted irradiance, if any, of the skin 102 may be transmitted through the clothing 106 based on a transmission property of the clothing 106, and that radiation and irradiance of the clothing 106 may be a first radiation 108. Where the concealed object 104 does not partially or wholly block irradiance of the skin 102, the irradiance of the skin 102 based on the transmissivity of the clothing 106 summed with the irradiance of the clothing 106 may be a second radiation 110. A difference of the first and second radiation 108, 110 may result in an edge. As each of the first and second radiation 108 and 110 may be received at a radiation detector, the difference of the first and second radiations 108 and 110 may be calculated and an edge or gradient may be defined based on their difference.

The existence of a gradient may define a primitive feature of an image detected at a digital camera. For example, an infrared radiation gradient across a two-dimensional plane of an image may define a line segment. Image features may be used to determine what type of objects of interest may be in an image and based on a classification of an object of interest a threat may be detected. For example, edge detection may be considered as a type of data reduction, as edge detection may enhance recognition of geometrical information in a presence of noise. This may lead to simple shape identification of an object assuming that a signal-to-noise ratio is large enough to form a connected or semi-connected boundary which can be extrapolated to a classifiable, recognizable, and identifiable target.

In general, edges may be described by a jump in intensity (either reflective or emissive) that may be due to one or more of the following: temperature and thermal radiance variation (including smooth and sharp variations) of a surface where an edge lies; transparent and opaque (in a sense of transmissivity of infrared radiation) materials that are stacked together, such as a body, metal, and clothing; surface deformation that affects an infrared emission; a blurring of an edge by diffraction, defocusing, and poor system modulation transfer function; and a jump in intensity may be due to a degree of detector array spatial uniformity (e.g., some portions of a focal plane array may detect a same intensity differently due to manufacturing variances which may need to compensation or adjusted for).

As discussed above, noise in detection of radiation may affect the ability to detect edges. In general, noise may be a small, random fluctuation on what would have been a smooth background if the background were noiseless. Noise affects quality of an image of detected radiation because small intensity variations caused by radiation contrast may be difficult to detect and recognize, as they may be difficult to distinguish from noise. Signal to noise ratio (SNR) is a metric to quantify a radiation of a desired signal to noise power. A high SNR value signifies a very dominant signal of detectable and recognizable information while low SNR value is dominated by noise where meaningful information is difficult to distinguish from the noise. Generally, for visible and infrared imaging systems, desired information is conveyed by spatial, temporal, spectral, and a mixture of these components. Therefore, large SNR derives from spatial, temporal, spectral, and a mixture of signal sources from which meaningful information may be utilized by feature extraction software.

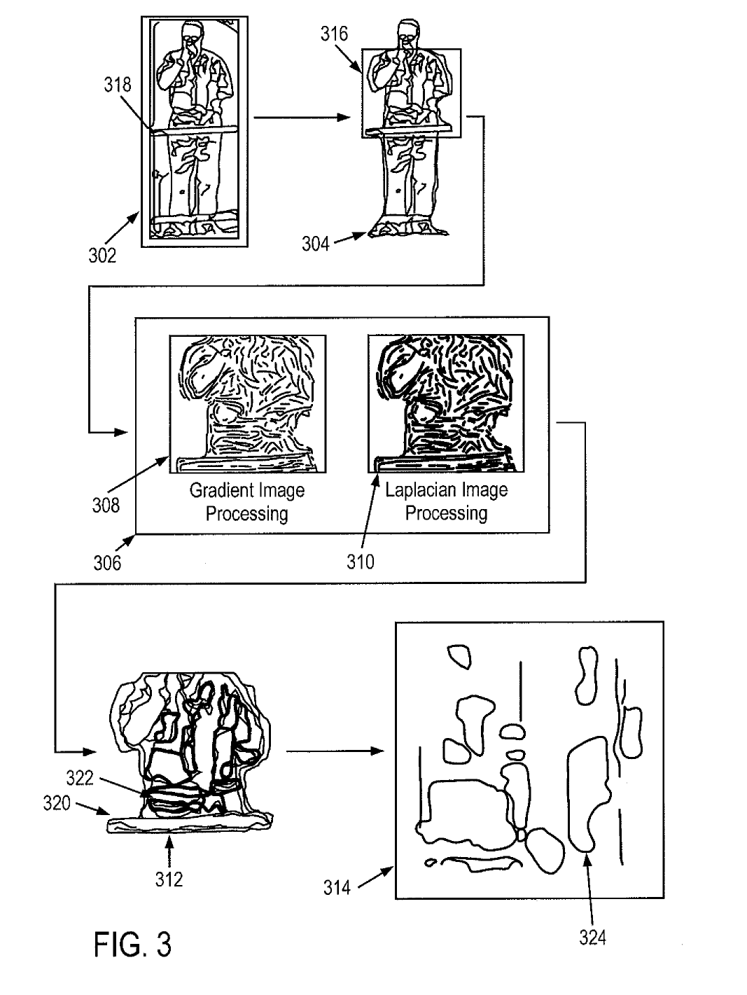

FIG. 2 is a block diagram illustrating a process of adding objects of interest into a knowledge base of objects of interest based on extracted image features. The knowledge base may be one or more database data structures. The process of FIG. 2 is one way in which to populate a knowledge base of classified and or non-classified objects of interest, which may be combined or substituted with other techniques. In general, in FIG. 2, extracted image features of an observed object of interest are used to populate the knowledge base.

For example, a first illustration 202 of a torso area shows no objects of interest to illustrate how a torso area of an individual may be observed by a digital camera under human-visible light. A second illustration 204 of a same torso area as observed by a detector of long or mid wavelength infrared radiation illustrates how a concealed object may be discerned based on edges 206 of the concealed object 208 being noticeable due to detected gradients of radiation contrast that result from viewing the concealed object 208.

A third illustration 210 of a same torso area illustrates a result of extracting image features from an image observed by a detector of long or mid wavelength infrared radiation, such as from an image based on the second illustration 204. Image features may be deconstructed into canonical features, such as line segments, shapes, and the like. The deconstructed image features may be stored and organized in data structures, as extracted image features. For example, a data model of image features may include classes for each of line segments and shapes, with sub-classes for each (e.g., classes that inherit a shape class), and those classes may have properties that define relationships between the instances of the classes.

As examples of data models for objects of interest, where the data models include a threat level indication, a model of a type of vest may be

Vest_{—}01
Large rectangular object
Large rectangular object centered on person
Has left shoulder strap
Has right shoulder strap
Conclude Threat level=30.

A data model of another type of vest may be:

Vest_{—}02:
Large rectangular object
Large rectangular object centered on person
Has left shoulder strap
Has right shoulder strap
Has left midpoint strap
Has right midpoint strap
Conclude Threat level=80.

Rules may use values associated with objects of interest to determine how to affect a threat level based on a detected object. An example rule for a vest that includes a concealed object of interest may be:

Vest_Concealment_{—}01:
If Vest_{—}01 Concealed Under Garment
   Then Raise Threat Level 25%.

Thus, for example, while a first vest has a threat level of 30, if it were concealed its threat level would be 30×125%.

As another example of a rule:

Vest_Concealment_{—}02:
If Vest_{—}02 Concealed Under Garment
   Then Raise Threat Level 50%.

As an example of processing the first example rule with the first type of vest found, a log of processing may look like (with comments included in “//”):

Vest_{—}01: Match=100%//a first type of vest was detected as a 100% match

Extra Features=50%//that vest has a 50% chance of including extra features

Adjusted Match=75%//the match level has been adjusted to account for the extra features potentially being misleading

Threat Level=30//there is a threat level of 30 because the first type of vest was detected and the adjusted match percentage was above a threshold

Concealment=True//the vest is detected as being concealed

Final Threat Score=37.5//the threat level is adjusted by 25% to account for the concealment according to the concealment rule

As another example of processing:

Vest_{—}02: Match=80%//a second type of vest was detected as an 80% match

Extra Features=0%//no extra features were detected

Adjusted Match=80%

Threat Level=80//there is a threat level of 80

Concealment=True//the vest is detected as being concealed

Final Threat Score=160//the threat level is adjusted by 50% to account for the concealment according to the concealment rule above.

A fourth illustration 212 illustrates a storage of image features of an object of interest extracted from an image, such as storage of the edges 206 of the concealed object 208 of the third illustration. The edges 206 may be classified and categorized based on their relative geometry, relationships to one another, and to contours of a human outline. In some implementations, in addition to storing extracted image features, metadata of an object may be stored. Examples of metadata may include relative temperature (e.g., a difference in temperature of an object compared to a human body), distance or orientation from a known or reference point (e.g., distance from a sign or wall of a building), probability assessments, and other information that may be useful for automated reasoning as it may relate to automatic threat detection.

As an identity and other information about a concealed object may be known when the concealed object is added to a knowledge base of objects of interest, the information that is known may be used to classify or otherwise describe an object of interest. For example, the identification of a wallet, which is an item that might not be considered a threat, may be used to classify a combination of edges and spatial relationships that represent an observed wallet as not being a threat. As another example, an identification of a digital camera as a possible threat may be used to classify a combination of edges and spatial relationships that represent an observed digital camera as a possible threat. As another example, an identification of a type of improvised explosive device as a threat may be used to classify a combination of edges and spatial relationships that represent that type of improvised explosive device as a threat. In addition to, for example, classifying whether a combination of image features is not a threat, is a possible threat, or is a threat, classification may include, for example, a ranking such that multiple possible threats, threats, or both may be ranked against each other to generate a list of threats by ranking.

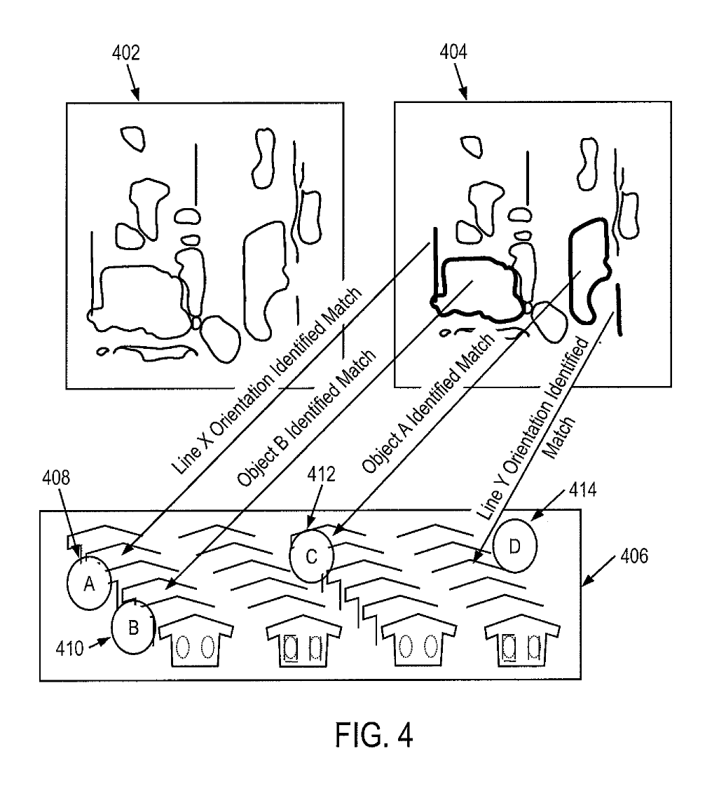

FIG. 3 is a series of illustrations depicting a process of extracting image features from an image. The process of FIG. 3 may be used, as examples, when adding objects of interest to a knowledge base of objects of interest or when identifying objects of interest to detect threats. In general, the process involves focusing on a particular section of an image including radiation contrast, processing the section of the image to attempt to improve clarity, and extracting features from the section of the image.

A first illustration 302 represents an infrared view of a human, where the infrared view may be from an infrared detector such as a long or mid wave infrared radiation camera. In the first illustration 302, edges, such as a group of edges 318 that make up an outline of a human figure, may be derived from the image based on gradients of radiation contrast being greater than a threshold value. For example, where change or difference from one pixel or group of pixels to an adjacent pixel or group of pixels are greater than a threshold number (representing a thermal gradient or discontinuity) a significant enough radiation contrast may be deemed to exist such that an edge may be highlighted and the highlighted edge may be superimposed on the image. In some implementations, a threshold for detecting radiation contrast may be a natural, passive consequence of physical properties of an infrared detector. For example, a threshold of detection may be referred to as a noise equivalent difference temperature, which may be a result of a smallest detectable difference in irradiance at an infrared detector.

In addition, the first illustration 302 may depict a result of a raw data image cleanup, which may include removing noise from an image thereby enhancing true thermal radiation information from a subject for more accurate edge detection and further image processing. This image cleanup may include incorporating effects of solar reflections, incorporating differences in known emissivities, incorporating effects of localized weather and environmental conditions, and the like.

As another example of detecting edges, a following series of equations that define radiation may be simplified into a series of cases to consider when determining whether one or more edges are to be part of an object of interest.

The equations that may be used to define radiation may include radiation from an object area and radiation from a surrounding area. Total radiation from an object area, Φ_{object} may be defined as Φ_{object}=τ_{C}ε_{O}φ_{O}(T_{O},T_{A})+ε_{C}φ_{C}(T′_{C},T_{A})+φ_{R}. Total radiation from the surrounding area, Φ_{surround} may be defined as Φ_{surround}=τ_{C}ε_{B}φ_{B}(T_{b},T_{A})+ε_{C}φ_{C}(T_{C},T_{A})+φ_{R}. For those equations, φ_{O}, φ_{B}, and φ_{C} may be thermal radiation from a concealed object, human body and cloth, respectively; ε_{O}, ε_{B} and ε_{C} may be emissivity of the concealed object, human body and cloth, respectively; T_{O}, T_{B}, T_{C}, and T′_{C} may be temperature of the concealed object, human body, cloth over the surrounding, and cloth over the concealed object, respectively; τ_{C} may be radiation transmission through the cloth; T_{A} may be an ambient temperature; and φ_{R} and φ′_{R} may be reflected radiation from a surrounding area and the object area.

The above equations may be simplified to a few situations under operational environments. In a first case, ambient temperature may be lower or close to a body temperature (T_{B}≧T_{A}), where temperature of a body is greater than temperature of the object (T_{B}≧T_{O}) and the temperature of the cloth surrounding a concealed object is greater than the temperature of the cloth over the concealed object (T_{C}>T′_{C}). Therefore, thermal radiation from the concealed object area is lower that the surrounding (Φ_{object}>Φ_{surround}).

In that case, equilibrium values of T_{O}, T_{C}, and T′_{C} may be determined by a set of parameters including heat conductivity of the object, heat conductivity of the cloth, heat convection, body, background temperatures, and heat radiation. Under these conditions, radiation reflected from the cloth, φ_{R}, could be much less than Φ_{object} and Φ_{surround}.

In a second case, hot ambient temperatures may be greater than temperature of a body (T_{B}<T_{A}) and thermal radiation from a concealed object area may be higher than a surrounding area (Φ_{object}>Φ_{surround}). In this situation, the first case may be reversed depending on the thermal absorption of the cloth, object, and body (assume more thermal absorption and less reflection).

An important study of the first and second case is that a concealed object is causing a temperature discontinuity between the cloth and the concealed object. This temperature discontinuity will cause a thermal discontinuity contour around the concealed object that may be detected by using a high sensitivity and high resolution thermal infrared imaging system.

In a third case, hot ambient temperatures may be greater than a temperature of a body (T_{B}<T_{A}) and thermal radiation from a concealed object area may be higher than a surrounding area (Φ_{object}>Φ_{surround}), similar to the second case. In the third case, a steady state of heat transfer may occur after some length of time because a heat capacity of a human being may be insignificant compared to an external environment. Because of that, a temperature difference between T_{O}, T_{A} T_{B}, T_{C}, and T (prime)_{C} may be insignificant. Under these conditions, radiation reflected from the cloth, φ_{R}, may be high and thermal contrast between a concealed object and a surrounding area may be insignificant. In this case, simultaneous detection through two spectral bands may be useful because common effects from φ_{R} may be eliminated by subtracting two images. This may enhance weak reflected or emitted thermal radiation from a concealed object. A similar situation may arise when the absorption of object, cloth, and body are lower.

Thus, based on the first and second cases, radiation of a concealed object tends to be significantly less than that of a surrounding area such that a concealed object may be detected based on this difference.

A second illustration 304 represents that a section of the image from the first illustration 302 has been selected for further processing. In this instance, a torso has been selected, as indicated by the box 316. Although a section of an image need not be selected, a section of an image may be selected to reduce an area of an image for which further processing may be performed or to otherwise focus further processing on a section of the image (e.g., processing of a torso may differ from processing of a section of a human figure where legs or shoes exist).

A box 306 indicates where image processing may occur to the section of the image that has been selected for further processing. In general, image processing may be used to try to improve an ability to extract image features, which may include removing noise, accentuating radiation contrast, and the like. In FIG. 3, image processing includes gradient image processing, as represented by a third illustration 308, and Laplacian or other edge detection image processing methods, as represented by a fourth illustration 310. Gradient image processing may smooth image gradients and reduce noise. Laplacian or other image processing may remove low frequency artifacts in an image that are from natural variations due to clothing, such that high frequency artifacts may reveal a presence of an anomaly corresponding to a concealed object, such as a cell phone or an explosive bomb vest. In some implementations, additional, fewer, or different types of image processing may be performed. For example, Laplacian of Gaussians, Canny Edge Operator, Morphological Method, and the like may be performed.

A fifth illustration 312 represents that features of an image are to be decomposed into canonical elements, which may include line segments and shapes. In particular, edges of the image may be decomposed into line segments, shapes (if possible), or both. For example, a line segment 320 is generated from an edge of the image, as no shape could be made of the edge, and, a shape 322 is generated from a group of edges rather than having separate line segments as a shape could be made of the edges.

A sixth illustration 314 represents image features that are extracted from the image of the fifth illustration 315. Image features that are extracted may be a subset of detected image features. For example, all image features which are not part of a human contour, clothing, or an environment may be extracted from an image (e.g., based on identification of human contours; identification of edges of clothing based on comparisons with known properties of types of clothing or comparisons with video surveillance to identify, for example, thicker parts of clothing, such as a collar having a shadow; identification of fixed, known objects of an environment, and the like). At least a subset of the extracted image features may be used to identify one or more objects of interest of the image. For example, the shape 324 may be used to identify a unique shape, which may be classified as part of a possible threat. For example an Improvised Explosive Device (IED) may consist of the following components: a trigger mechanism (wires and switch), electrical source (for detonation) and explosives, each of which each is comprised of a collection of known shapes or configurations. By comparing each unique shape to known classified shapes a determinate can be made if a threat shape, object, or collection of shapes and objects exists.

To determine whether a group of one or more edges are part of an object of interest (e.g., such that they are to be extracted from an image; e.g., to increase a confidence of an assessment of edges being part of an object of interest), texture, contour, and object morphology may be used. Texture may refer to a variation in adjacent pixel intensities. Grouping of pixels with similar intensities (e.g., groups of pixels having similar texture) may be used to determine object morphology and contour. As an example of using texture, texture analysis may reveal information to separate an electronic device from an explosive based on edge and curvature properties. Overlaying thermal radiance contours on segmented human individual contour may provide further evidence for presence of concealed objects. For example, to decompose image features that may represent an object of interest, edges that represent outlines or contours of humans in a scene may be determined and separated from other edges. The remaining edges on outlines of humans may be used to determine which edges to consider as objects of interest.

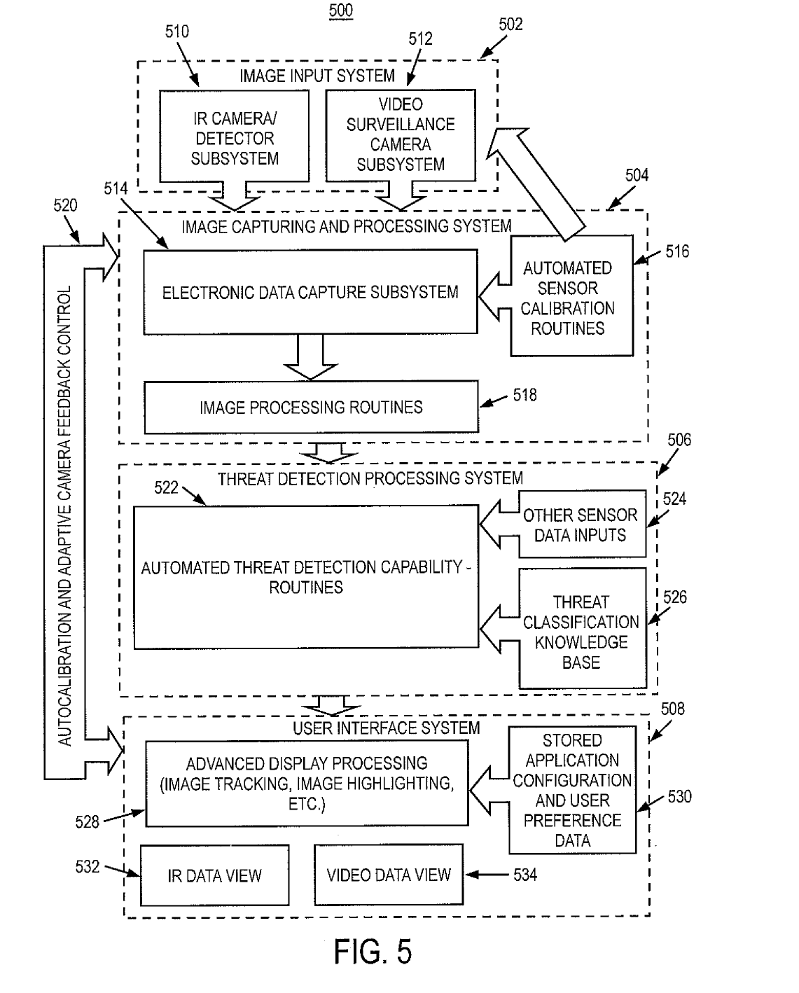

FIG. 4 is a series of illustrations depicting a process of detecting objects of interest from extracted image features. The extracted image features that are used to detect objects of interest may be a result of the process of FIG. 3 of the extraction of image features. In general, an object of interest may be made up of one or more image features, such as line segments and shapes. To detect objects of interest from extracted image features, a variety of properties of image features may be used to determine whether one or more image features constitute an object of interest.

A first illustration 404 includes a combination of image features that may have been extracted from an image. Any combination of image features may be extracted from an image. In addition to image features being extracted from an image, metadata about the image features may be included.

In a second illustration, a combination of image features and properties of image features are selected to determine whether they are an object of interest that may be identified from a knowledge base of objects of interest 406.

Based on an inference engine match between image features, properties of image features, or both and objects of interest in a knowledge base, an assessment may be made as to whether the image features constitute a threat. For example, in FIG. 4, an image feature line X having a particular orientation is a match as an object of interest A 408, a shape of an object has a match as an object of interest B 410, a shape of another object has a match as an object of interest C 412, and an image feature line Y having a particular orientation is a match as an object of interest D 414. A combination of those objects of interest may constitute a particular object of interest or each of them individually may be an object of interest, where properties of the objects of interest may be used to determine whether an object of interest is a threat. For example, the object of interest B 410 may be identified as being a threat in the knowledge base 406 of objects of interest. For example an Improvised Explosive Device (IED) may consist of the following components: a trigger mechanism (wires and switch), electrical source (for detonation) and explosives, each of which each is comprised of a collection of known shapes or configurations. By comparing each unique shape to known classified shapes a determination may be made as to whether a threatening shape or object exists.

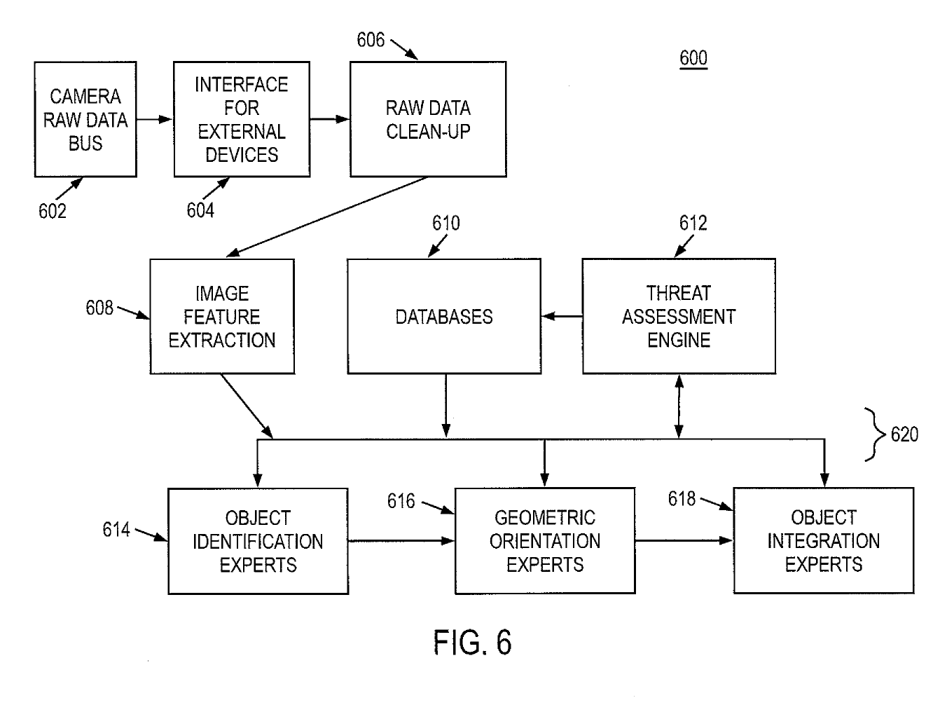

FIG. 5 is a diagram of a system 500 and process to acquire or capture images and to detect objects of interest from images. The system 500 includes an image input system 502, an image capturing and processing system 504, a threat detection processing system 506, and a user interface system 508. In general, a physical area, which may include people, may be observed by the image input system 502, from which images may be captured and processed by the image capturing and processing system 504. Processed images or other results from image processing may be analyzed by the threat detection processing system 506, where threats may be detected in the results from the image processing. Determinations from the threat detection processing system 506 may be displayed by the user interface system 508. In addition, the user interface system 508 may cause information from other portions of the system 500 to be controlled or displayed.

As discussed above, the image input system 502 may be used to observe an area that may include people. The image input system 502 includes an infrared camera 510 and a video surveillance camera 512. The infrared camera 510 may be able to detect medium wavelength or long wavelength infrared radiation, which may include having a sensitivity to radiation emitted between three and eight micrometers (μm) of wavelength for medium wavelength radiation detection, or between eight and fifteen micrometers μm of wavelength for long wavelength radiation detection. As examples, the infrared camera 510 may be a quantum well infrared photodetector camera (QWIP; e.g., a focal plane array of QWIPs), an indium antimonide (InSb) detector, or another type of highly-sensitive array of infrared photodetectors. The infrared camera 510 may include a dual band detector, which may detect radiation from both medium and long wavelengths. A dual band camera including MWIR and LWIR detecting capabilities may be used to add results together, which may alleviate problems related to having a narrow band for detection of infrared radiation. The image feed provided by the infrared camera 510 may be a raw data image feed (e.g., images may be in accordance with a RAW image format having minimal processing, if any). In alternative implementations, the infrared camera 510 may include hardware, software, or both for capturing and processing infrared image data. In some cameras an image capture (e.g., including frame grabber electronics) may be included, in other cameras it may be an external box or function.

The video surveillance camera 512 may be used to observe a same or similar area as the infrared camera 510, and may observe the area using human-visible light. As examples, the video surveillance camera 512 may be a commercial grade black and white camera or a high definition color video surveillance camera. To observe a same or similar area, for example, the video surveillance camera may be mounted with the infrared camera 510 and focus on a same area (e.g., being five to one hundred meters from the video surveillance camera 512). Images of the video surveillance camera 512 may be used to assist in detecting an individual that includes an object of interest, such as an object considered a possible threat, as determined by the infrared camera 510. The video surveillance camera 512 may also provide a raw data image feed, or may provide captured, processed images.

The image input system 502 may include one or more optical elements having a focal length corresponding to a zone of interest to facilitate monitoring thermal radiance levels of human traffic at a fixed or variable distance. For example, each of the video surveillance camera and the infrared camera 510 may be set up (e.g., having a common set of optical element or separate optical elements) such that they are able to focus on objects having a distance of five meters to one hundred meters away, as that distance may be preferable in providing a sufficient field of view for viewing multiple people in a public area and the distance may provide a sufficient image resolution from which to determine whether an object of interest is a threat (e.g., a lens may have a focal length of four hundred micrometers). The image input system 502 may be a portable device including a portable camera, which may be a hand-held device, and may further be a wireless device (e.g., the image input system 502 may be a QWIP sensor camera disguised as a hand-held Charge-Coupled Device camera). In other implementations, the image input system 502 may be a fixed device mounted on a building, or a vehicle.

Output of the image input system 502 may be received by the image capturing and processing system 504. For example, video feeds, such as digital video feeds, from the infrared camera 510 and the video surveillance camera 512 may be received at a computer system that performs the operations of the image capturing and processing system 504. The output may be captured at the electronic data capture subsystem 514 of the image capturing and processing system 504. For example, raw infrared image data may be stored by the electronic data capture subsystem 514 in a buffer or storage device that may be accessed by the image processing routines 518 for further processing. Such processing may be used for post-event forensics. For example, post-event forensics may include being able to analyze an event or situation with corresponding video data.

In general, the image capturing and processing system 504 may capture raw image data, process the captured image data, and provide processed image data to the threat detection processing system 506. For example, raw image data from the image input system 502 may be stored in volatile memory by the electronic data capture system 514, which may compress the data. Then, the stored image data may be processed by the image processing routines 518.

The image capturing and processing system 504 may include hardware, software, or both to capture and acquire infrared and human-visible video data at sufficient data rates for real-time surveillance. This may also include necessary persistent data storage and volatile data storage to perform real-time data acquisition, and communications protocols and techniques to interact with each of the infrared and video surveillance cameras 510, 512. Communications protocols and techniques may include, as examples, TIA-422 (TELECOMMUNICATIONS INDUSTRY ASSOCIATION (TIA)/ELECTRONIC INDUSTRIES ALLIANCE (EIA) Standard 422 for Electrical Characteristics of Balanced Voltage Differential Interface Circuits), LVDS (Low Voltage Differential Signaling), Fiber-optics, and Wireless (e.g., Radio Frequency or WIRELESS-FIDELITY).

To calibrate image data (e.g., for optimal resolution and clarity) from the infrared camera 510, the video surveillance camera 512, or both, or to calibrate the infrared camera 510, the video surveillance camera 512, or both the automated sensor calibration routines 516 may interface with the electronic data capture subsystem 514 or the cameras 510, 512. The calibration routines 516 may include operational policies, procedures, or both for camera calibration across various operating conditions (e.g., during night time, during precipitation, and the like). For example, a set of settings for capturing night time image and infrared data may be sent to the electronic data capture subsystem 514 (e.g., triggered by a time of day), which may interface with the infrared camera 510 and the video surveillance camera 512 to cause those settings to be applied. The automated sensor calibration routines 516 may be triggered by internal events, such as a time of day or system reset; observation of infrared or video surveillance image data, such as by determining a temperature outside or a darkness of ambient light; or other stimuli. In addition to performing calibration by the automated sensor calibration routines 516, calibration may be performed through the user interface system 508 (e.g., manually in response to user input or automatically), as shown by an auto-calibration and adaptive camera feedback control loop 520. By effectively calibrating monitored thermal radiance levels and taking advantage of the robustness of monitoring at a fixed distance, a calculated differential thermal radiance may be buffered against large changes in the ambient background including, as examples, temperature, wind conditions, humidity, hail, and snow, which may be determined using a dual band or two-color, or dual band IR camera solution.

The image processing routines 518 perform processing on captured image data. The captured image data that is processed by the image processing routines 518 may include compressed image files (including still and motion picture image files). The processing that is performed may include one or more techniques that may perform image manipulation or analysis including filtering of data, such as image noise; improving resolution or clarity of image features; detecting edges; and extracting image features (as described above with reference to FIG. 4). The result of the processing may include, as examples, images including extracted image features or data structures representing extracted image features. For example, a collection of data structures may include a first data structure representing a shape having three edges and a second data structure representing a line segment with a property describing the distance to the center of the shape represented by the first data structure.

The threat detection processing system 506 may determine whether extracted image features from the image capturing and processing system 504 represent threats. In particular, determination of whether extracted image features represent a threat may be performed by automated threat detection capability routines 522, which may use sensor data from other sensor data inputs 524 and may use a threat classification knowledge base 526.

In general, the automated threat detection capability routines 522 is an automated reasoning (e.g., inference) engine, which may also be referred to as an expert system, that may evaluate extracted image features against the threat classification knowledge base 526. As an automated reasoning engine, rather than, for example pattern match images of known threats with observed images, image features in combination with properties of image features may be run against rules to determine whether a threat exists. The automatic threat detection capability routines 522 may contain codified logic of rules created in the threat classification knowledge base 526. For example, the real-time inference engine may compile rules of the threat classification knowledge base 526 as “if then rules” into standard computer “C” or “C++” code that may be compiled into machine executable code used by the automated threat detection capability routines 522.

The automated threat detection capability routines 522 may be an expert system such as an expert system adapted from SHINE (Spacecraft Health Inference Engine), which is an ultra-fast rules engine that provides real-time inferences, which may be able to inference over one billion rules per second on desktop class computer processors.

The automated threat detection capability routines 522 may segment extracted image features into other independent elements as part of the reasoning process, such as object types, geometric orientation, high-level integration, and threat assessment categories. The use of an expert system may enable a dynamic plug-and-play approach to decomposing threat types into independent manageable pieces that can be added and removed as needed with minimal contamination or impact of existing capabilities. For example, as new objects (e.g., explosive types) are identified, they may be easily added to the knowledge base 526. As another example, as new techniques are developed for threat formation and assessment, they may be simply included in the automated detection capability routines 522.

Using an expert system or inference engine may result in a cost savings as an entire system need not be updated in response to new threats or characteristics of threats. For example, knowledge base 526 may be updated. System distribution and deployment may be greatly improved as there may only be one basic code set to maintain for the expert system. Based upon field trials and updated threat categories, system capabilities can be added and removed easily. For example, the threat detection system 500 may be adapted to prevent theft in enterprise, departmental and retail stores, and other facilities where theft of merchandise is a concern by changing, for example, the knowledge base 526 to include records of items that may relate to theft.

The threat classification knowledge base 526 may include one or more knowledge bases that store information about image features from which threats may be classified. The information may include threat classification rules and other logic. The rules of the knowledge base 526 may define characteristics to assist with identifying unique or generic objects that correspond to objects of interest. For example, a generic rule of the knowledge base 526 may define that a particular shape of a particular size and orientation in combination with another shape is within a class of improvised explosive devices and a more specific rule may identify the combination of image features and image properties, with additional properties as an improvised explosive device that is a nail bomb.

The information about image features in a rule may include, for example, line segments; shapes; relative spatial orientations between line segments, shapes, contours of humans, and other objects of interest; and other information that pertains to defining objects of interest for detection. For example, one record of a database may define a certain shape having a range of distance from a line segment as a class of improvised explosive devices. Records in the knowledge base 526 may include any degree of threats or objects of interest that are not threats, including, as examples, verified threats, possible threats, observations that are not classifiable, and the like.

In addition to determining whether an object of interest is a threat, the knowledge base 526 may have rules that provide an assessment of a degree of threat (e.g., possible threat, minor threat, and major threat) and a degree of certainty of a classification (e.g., 60% chance of being any type of threat).

The information in the knowledge base 526 may be obtained from one or more sources, including, observations, such as the observations discussed with reference to FIGS. 2-4; downloading from a repository of threat information; and the like.

In addition to the automated threat detection capability routines 522 using the knowledge base 526, other sensor data inputs 524 may be used to assist with determining whether an object of interest is a threat. The other sensor data inputs 524 may include, as examples, radiation level detectors (e.g., Geiger counter), acoustic sensors (e.g., microphone), millimeter (mm) wave sensor or detector (active or passive), radar or LIDAR (laser radar) sensors, or any other active or passive environmental sensors.

The user interface system 508 may display information to a user and allow for interaction with the system 500. The user interface system 508 includes advanced display processing 528, infrared data view 532, video data view 534, and stored application configuration and user preference data 530. The infrared data view 532 may provide an infrared image to a user which may include overlays with threat identification information. Similarly, the video data view 534 may provide a human-visible light observed image view to a user with overlays with threat identification information. For example, the views 532, 534 may be window panes of a graphical user interface. Threat identification information may include any combination of information, such as rankings of threats in a scene; identifications of a human or object in an image; a text description of a threat; and the like. The threat identification information may be provided by the advanced display processing 528, which may process infrared and video data to provide a visual interpretation of the threats for viewing at either of the views 532, 534. For example, a video image of a scene may be combined with a colored overlay of a human contour over a person in the video image, and the color of the overlay may indicate a degree of threat of the person (e.g., based on objects carried by the person).

The application configuration and user preference data 530 may provide settings for parameters used in advanced display processing 528. For example, there may be different types of overlays (e.g., ones with thicker or thinner lines, or difference color schemes for objects of interest) available for identifying a person carrying an object of interest a user may prefer to have threats displayed with a particular type of overlay. A setting corresponding to the particular type of overlay may be stored at the application configuration and user preference data 530, which may be used by the advanced display processing 528 to determine which type of overlay to use.

Although FIG. 5 includes a certain number and type of components, the system 500 may include additional, fewer, or different components. For example, in some implementations the video surveillance camera 512 need not be included as part of an image input system 502. As another example, the image capturing and processing system 504 may be integrated with the image input system 502 in a single device. As another example, the image input system 502 may include a pair of stereo video surveillance cameras. Stereo optical video surveillance cameras may assist with scene range napping, segmentation of humans out of a scene, and initial charting of body outlines that can be used for automatic tracking and identification of humans as they move thought a zone of interest or coverage. As another example, a QWIP long wavelength infrared camera may be combined with an InSb medium wavelength infrared camera. As another example, each of the cameras 510, 512 may include a zoom lens or multiple lenses for focusing from multiple viewing distances.

As another example, determinations may be made as to whether monitored thermal gradients or discontinuity data for a section of a zone of interest is associated with a calibrated thermal data level for one or more factors including ambient background, an exterior surface of a human, a prototypical clothing material, personal article, and an explosive material. Data associated with post-processed thermal gradient data calibrated for one or more factors including ambient background, an exterior surface of a human, clothing, personal articles, computing devices, and an explosive material can be stored in a data repository. Calibrated thermal gradient levels may be determined by empirically associating factors at a distance corresponding to a length between the radiation detection unit and a zone of interest.

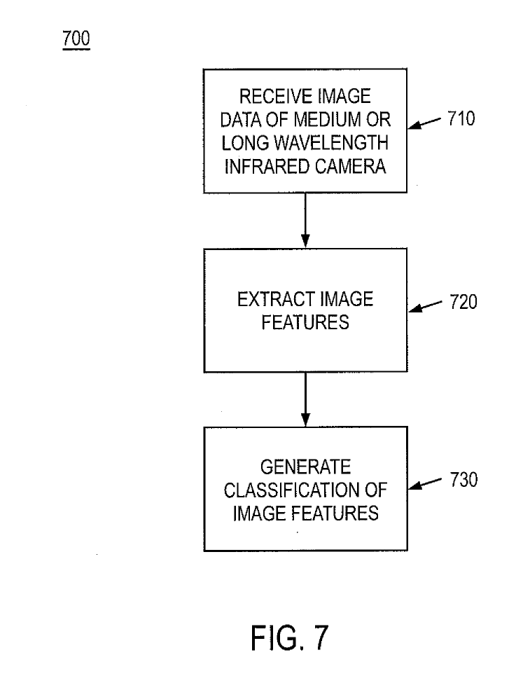

FIG. 6 is a block diagram of a system 600 to acquire images and detect objects of interest from images using automated reasoning. In general, similar components of the system 600 of FIG. 6 may operate similarly to similar components of the system 500 of FIG. 5. For example, the knowledge bases 610 may operate as an implementation of the knowledge base 526.

In general, the system 600 of FIG. 6 differs from the system 500 of FIG. 5 for at least the reason that it includes software reasoning modules or “experts”, including the reasoning modules for: object identification experts 614, the geometric orientation experts 616, and the object integration experts 618.

In general, the system 600 operates by receiving raw image data at a camera raw data bus 602, which may receive raw image data from one or more cameras, such as a long wavelength infrared camera. The image data from the bus 602 is received at the interface for external devices 604. The interface for external devices 604 may provide a level of abstraction from cameras and may provide for interfacing with cameras. For example, the interface for external devices 604 may request image data from a camera and receive the image data though the camera raw data bus 602.

The interface for external devices 604 causes image data to be cleaned up by a raw data cleanup 606, which may be a combination of one or more of hardware and software processes. Raw data cleanup 606 may, for example, remove noise from image data. Results of raw data cleanup 606 may be sent to a component for image feature extraction 608, where image features of cleaned-up image data may be extracted, for example, into data structures that represent image features of an image. Extracted image features may be made available to other components of the system 600 by the common data bus 620. For example, extracted image features may be stored at knowledge bases 610, sent for threat identification at the reasoning module experts 614, 616, 618, or processed by the threat assessment engine 612.

The reasoning module experts 614, 616, 618, which may be discrete software modules, may work together to identify objects that may be threats by processing extracted image features with assistance from rules or logic corresponding to objects of interest generated at the knowledge bases 610. For example, the object identification experts 614 may identify individual image features of extracted image features, the identified image features may be processed by the geometric orientation experts 616 to determine an orientation of the image features for further processing, which may include determining a rotation and spatial relationship to other identified features. Then, the object integration experts 618 may take results of the identified features and their orientation to determine whether a combination of identified features constitutes a threat.

Results of the experts 614, 616, 618 may be used by the threat assessment engine 612 to determine whether an identified combination of image features constitutes a threat and, if so, a degree of threat. For example, an identified combination of image features may be considered one of not being a threat, being a possible threat, or being a threat. Then, threats may be ranked by the threat assessment engine 612. For example, some classifications of threats may be considered more important than others. For example, a book may be considered less of a threat than an explosive device. Information from the threat assessment engine 612 may be fed to a user interface for display and user interaction. For example, a ranking of threats may be displayed to a user along with a location of a person carrying a threat overlaid on an image observed with a human-visible light camera, an identification of a location of a threat on a person (e.g., torso, arm, legs), and a type of threat on a person (e.g., which may include a coloring of a contour of a human as part of the overlay, such as green representing no threat, yellow representing possible threat, and red representing a threat; and an identification of a threat, such as an explosive device).

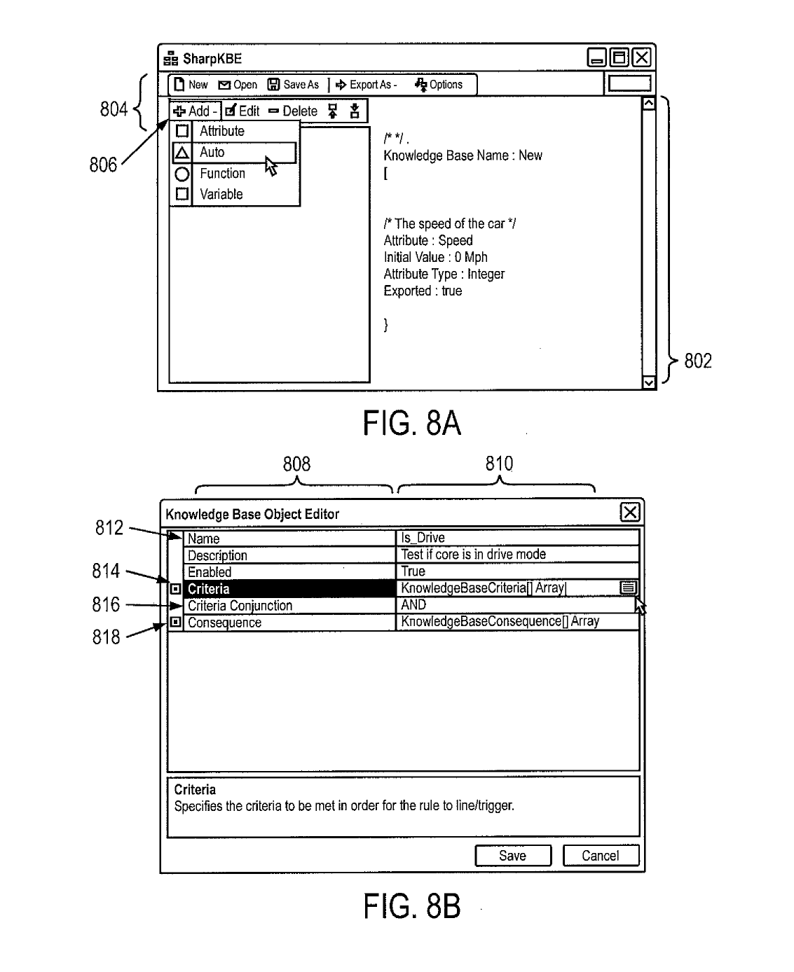

FIG. 7 is a flowchart illustrating a process 700 of generating a collection of classified image features. In general, the process 700 involves receiving image data observed by a medium or long wavelength infrared camera (710); extracting image features from the image data (720); and generating a classification of image features (730). The process 700 may be performed by the system 500 of FIG. 5 or the system 600 of FIG. 6.

Image data of a medium or long wavelength infrared camera is received (710). The image data may be raw image data or processed image data. The camera may be positioned five to one hundred meters from a zone of interest that may include humans.

In some implementations, image data from multiple infrared cameras may be received or a camera may include the ability to observe dual band images of both medium and long wavelength infrared radiation.

Image features are extracted from image data (720). The image features may include line segments and shapes. In addition to extracting image features, metadata of image features or a scene may also be extracted. Extracting of image features may include generating instances of one or more data structures to represent the image features and the data structures may include many different types of properties of the image features, such as size (e.g., length and width), number of edges, geometric definition of a shape (e.g., a definition based on edges that constitute a shape (e.g., defined by vectors that represent edges) or a definition based on sub-shapes that define a shape (e.g., a combination of triangles)), orientation, location within a human contour, location in a scene, relationship in location compared to other image features, and the like.

A classification of image features is generated (730). Generating the classification of image features may include determining, based on image features of known objects of interest, an identification of an object of interest defined by extracted image features. The classification may include a specific classification, generic classification or both. For example, based on extracted image features of a line segment of a certain thickness connected by a curved line to a rectangle, a classification may identify the image features collectively as representative of an explosive device or other objects of interest, and, more particularly, a suicide bomb. Determining a classification may include checking extracted image features against a rule. Following the prior example, a rule may define that a line segment within a range of thickness with a curved line to a rectangle within a range of size fits within the particular generic and specific classifications.

Although the process 700 of FIG. 7 includes a certain number and type of sub-processes, additional or different sub-processes may be implemented. For example, raw image data cleanup and further processing of image data may be performed. For example, white balance, color saturation, contrast, and sharpness processing of image data may be performed as image data cleanup, as well as further processing such as gradient image processing and Laplacian image processing.

As another example, in coordination with receiving infrared image data, image data of cameras that detect human-visible light may be received. For example, image data from a high definition video camera may be received and that camera may focus on a same zone of interest as the infrared camera. Image data from a human-visible light camera may be combined with detected objects of interest, such as detected threats, to, for example, provide an overlay with an identification of a location of a detected object of interest.

As another example, image data may be received from a device having a focal plane array of detectors capable of detecting infrared radiation having a wavelength between three and fifteen micrometers. For example, a dual band infrared camera may be used for detecting medium and long wavelength infrared radiation.

As another example, a classification of extracted image features may be displayed to a user. Displaying classification information may include, as examples, displaying an alert that a threat has been detected and a type of threat; displaying a ranking of threats; displaying a color-coded overlay over an image of a human observed in human-visible light; and the like.

As another example, threats, once detected, may be continually tracked. For example, as a person who is indicated as carrying a threat continues to move, an overlay indicating the person is carrying a threat may continue to be displayed on the moving image. As part of tracking threats, detection of threats may be continually reevaluated (e.g., to determine if threat detection resulted in a false positive or false negative).

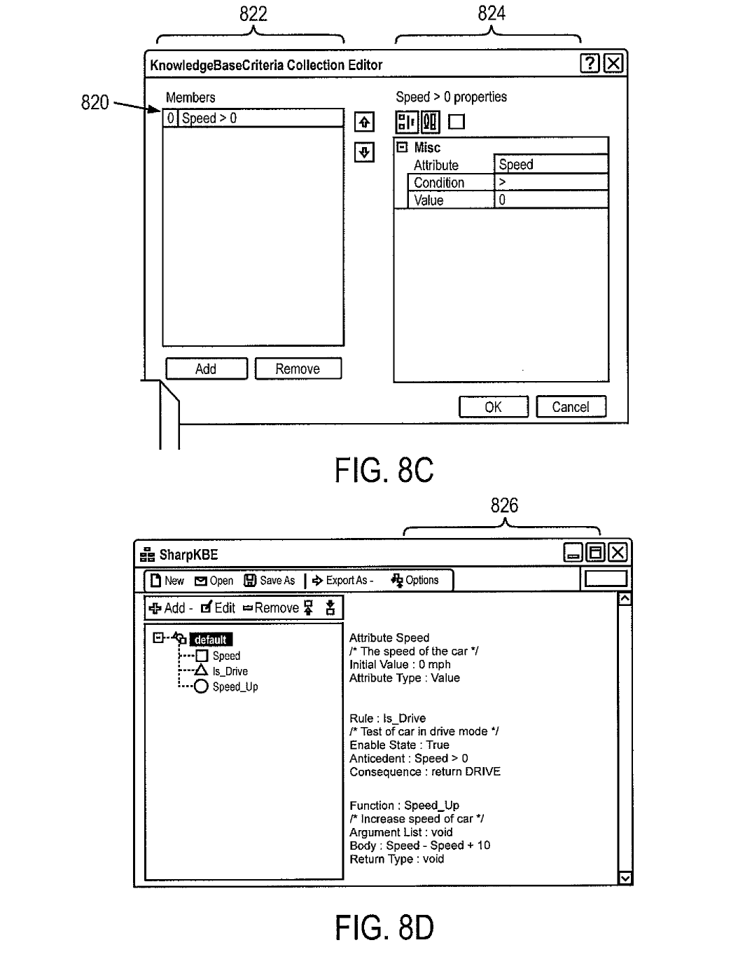

FIGS. 5A-8D are a series of illustrations depicting user interfaces that may be used to generate detection reasoning rules. In general, the user interfaces of FIGS. 8A-8D are graphical user interfaces that may be used to generate reasoning rules that may be used to ascertain or determine various objects of interest from extracted image features. The reasoning rules may be stored in a knowledge base, such as the threat classification knowledge base 526 of FIG. 5, and the reasoning rules may include logic rules specific to the detection of specific objects. The reasoning rules themselves may be a combination of rule criteria and consequences that may occur in response to the rule criteria being met (e.g., If-Then logic).

In general, the user interface of FIG. 8A includes a text editor area 802 and menu buttons 804. The text editor area 802 may be used to generate reasoning rules, and associated logic and components that assist in object detection, such as attributes, functions, and variables. For example, the text editor area 802 includes an attribute speed for a knowledge base named Name.

The menu buttons 804 may be used to perform actions related to editing detection rules and their components that are displayed in text editor area 802. For example, an “add” button 806 may be used to add a data structure to the underlying knowledge base represented in the text editor 802, such as a data structure representing an attribute, rule, function, or variable.

The user interface of FIG. 8B may be used to edit attributes of an object of a knowledge base, such as attributes of a rule. The first column 808 includes descriptions of attributes and the second column 810 includes values of attributes in a same row as a particular description. For example, the first row 812 includes a description “Name” of an object in the first column 808 and a value Is_Drive for the Name of an object in the second column 810. Criteria of a rule may be viewed in the user interface. For example, the fourth row 814 of the user interface includes an area for viewing criteria of a rule (and, for example, further criteria may be viewed through the use of a collapsible tree of criteria), the fifth row 816 includes criteria conjunction (e.g., a Boolean operator to be tested across criteria as part of a rule), and a sixth row 818 includes a consequence of the rule being met (e.g., one or more actions to be performed in response to criteria of a rule being met, such as raising a threat level by a certain amount of points).

The user interface of FIG. 8C may be used to edit criteria of a rule, such as the criteria of the rule in the user interface of FIG. 8B. As an example, an attribute speed is a first member 820 of conditions of a rule listed in a list of members 822. Criteria of the member appear in a list of criteria 824, where example criteria of that member include an attribute having the name speed being connected to a value by the condition greater than ‘>’ to a value of zero. Thus, for example, if an attribute of a detected object were decomposed such that an attribute speed had a value greater than zero and the example condition were processed, the condition would be met such that, for example, a consequence may occur.

The user interface of FIG. 8D is similar to the user interface of FIG. 8A with an exception being that that a text editor window 826 has additional language constructs. For example, it includes a rule named Is_Drive being enabled that has a condition “Speed>0,” which may be a result of user input with the user interface of FIG. 8C, and a consequence of returning an attribute DRIVE, which may indicate that a vehicle is in drive if the condition of the rule is met.

Although the user interfaces of FIGS. 8A-8D include certain features and components, in implementations different, additional, or varying features, components, or both may be included.

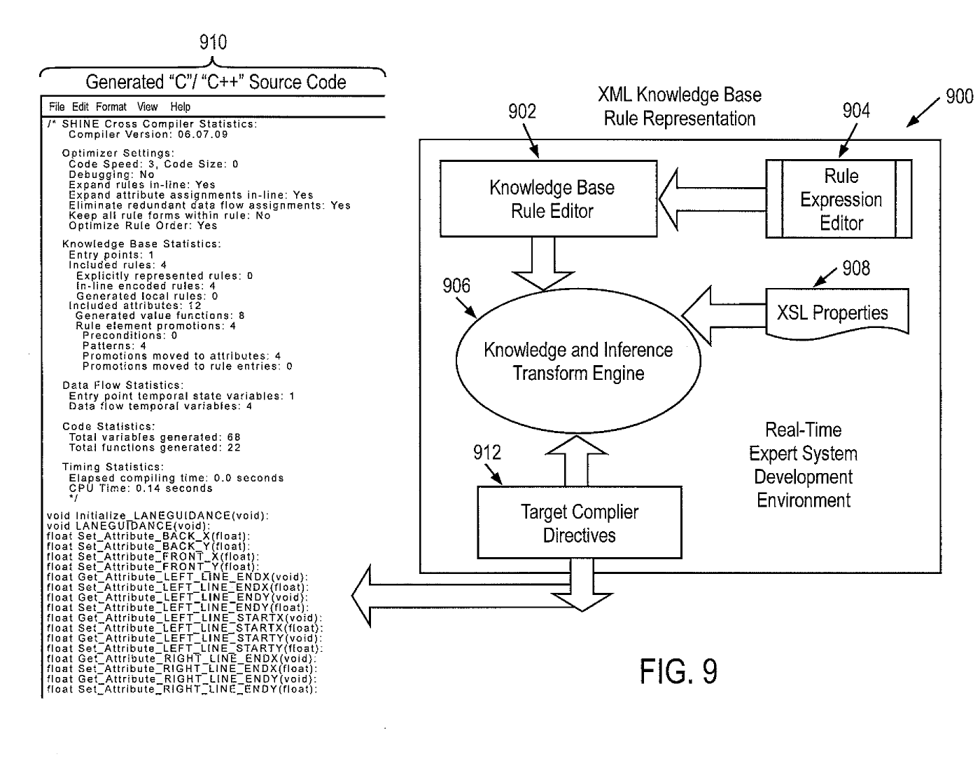

FIG. 9 is a block diagram of a system 900 to generate source code for detection. In general, the system 900 includes a knowledge base rule editor 902 that may be used in conjunction with a rule expression editor 904 to generate rules. The knowledge base rule editor 902 may have the user interface of the FIGS. 8A and 8D and may be used to edit rules of a knowledge base in coordination with other constructs of a knowledge base language used to generate rules, such as functions, attributes, and the like; whereas, the rule expression editor 904 may have the user interfaces of FIGS. 8B and 8C and be used to edit specific criteria for a rule.

Rules that are generated by the editors 902 and 94 may be interpreted by the knowledge and inference transform engine 906 in conjunction with XSL (eXtensible Stylesheet Language) properties 908 to transform the rules to generate C or C++ source code 910. Transforming rules may involve use of compiler directives 912 that may be included in the source code 910. The source code 910 may be compiled for use by a threat detection system. For example, the compiled source code 910 may be used to generate experts or new application logic sub-routines or software components that may be integrated with the overall threat detection system.

The subject matter described herein can be implemented in digital electronic circuitry, or in computer software, firmware, or hardware, including the structural means disclosed in this specification and structural equivalents thereof or in combinations of them. The subject matter described herein can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other in a logical sense and typically interact through a communication network. The relationship of client and server arises by virtue of computer programs running on the respective computers and having a client-server relationship to each other.

The subject matter described herein has been described in terms of particular embodiments, but other embodiments can be implemented and are within the scope of the following claims. For example, operations can differ and still achieve desirable results. In certain implementations, multitasking and parallel processing may be preferable. Other embodiments are within the scope of the following claims

What is claimed is:

1. A computer program product, tangibly embodied in a computer-readable media, the computer program product being operable to cause data processing apparatus to detect concealed objects of interest in a zone of interest in which human traffic is present by performing operations comprising:
receiving an image from a device comprising a focal plane array having a sensitivity to radiation having a wavelength from 3 to 15 micrometers, the image of the zone of interest in which the human traffic is present, and the human traffic being at a distance of 5 to 100 meters from the device;
processing the image by applying one or more image processing techniques comprising gradient image processing to enhance edges based on discontinuities in thermal gradients;
extracting features of the image in which the human traffic is present based on infrared radiation contrast associated with a human in the human traffic, the extracting comprising:
detecting a plurality of edges, each of the edges being a result of thermal gradient discontinuities; and
decomposing at least some of the edges into image features representing spatial objects in an image processing environment, the spatial objects comprising line segments and shapes, the image features represented by one or more data structures;
generating a classification of the image features from a knowledge base populated with classifications of objects of interest being observed, concealed objects on a human; the classification generated by a rule processing engine to process the image features; the classifications comprising threats; the classifications generated by extracting features of images from the observed, concealed objects on the human to generate rules for the classifications; and
displaying data characterizing the classification of the image features being associated with the human, the data characterizing a threat if the classification is one of the threats.

2. The product of claim 1, wherein the extracting features further comprises generating metadata of the image features and the generating the classification further comprises the rule processing engine to process the metadata of the image features.

3. The product of claim 1, wherein the device is one of a quantum well infrared photodetector or an indium antimonide (InSb) detector.

4. The product of claim 1, wherein the device is a long wavelength digital camera having a sensitivity to radiation emitted between 8 and 15 micrometers.

5. The product of claim 1, wherein the receiving, the extracting, the generating, and the displaying the data are performed in approximately real time, including near-real time image processing, threat detection, and classification.

6. A method of detecting concealed objects of interest in a zone of interest in which human traffic is present, the method comprising:
receiving an image from a device comprising a focal plane array having a sensitivity to radiation having a wavelength from 3 to 15 micrometers, the image of the zone of interest in which the human traffic is present, and the human traffic being at a distance of 5 to 100 meters from the device;
processing the image by applying one or more image processing techniques comprising gradient image processing to enhance edges based on discontinuities in thermal gradients;
extracting features of the image in which the human traffic is present based on infrared radiation contrast associated with a human in the human traffic, the extracting comprising:
detecting a plurality of edges, each of the edges being a result of thermal gradient discontinuities; and
decomposing at least some of the edges into image features representing spatial objects in an image processing environment, the spatial objects comprising line segments and shapes, the image features represented by one or more data structures;
generating a classification of the image features from a knowledge base populated with classifications of objects of interest being observed, concealed objects on a human; the classification generated by a rule processing engine to process the image features; the classifications comprising threats; the classifications generated by extracting features of images from the observed, concealed objects on the human to generate rules for the classifications; and
displaying data characterizing the classification of the image features being associated with the human, the data characterizing a threat if the classification is one of the threats.

7. The method of claim 6, wherein the extracting features further comprises generating metadata of the image features and the generating the classification further comprises the rule processing engine to process the metadata of the image features.

8. The method of claim 6, wherein the device is one of a quantum well infrared photodetector or an indium antimonide (InSb) detector.

9. The method of claim 6, wherein the device is a long wavelength digital camera having a sensitivity to radiation emitted between 8 and 15 micrometers.

10. The method of claim 6, wherein the receiving, the extracting, the generating, and the displaying the data are performed in approximately real time, including near-real time image processing, threat detection, and classification.

11. A computer program product, tangibly embodied in a computer-readable media, the computer program product being operable to cause data processing apparatus to perform operations comprising:
receiving an image from a device comprising a focal plane array having a sensitivity to radiation having a wavelength from 3 to 15 micrometers;
extracting features of the image, the extracting comprising:
detecting a plurality of edges, each of the edges being a result of infrared radiation contrast; and
decomposing at least some of the edges into image features representing spatial objects in an image processing environment;
generating a classification of the image features from a knowledge base populated with classifications of objects of interest being observed, concealed objects on a human; the classification generated by a rule processing engine to process the image features; the classifications comprising threats; and
displaying data characterizing the classification of the image features, the data characterizing a threat if the classification is one of the threats.

12. The product of claim 11, wherein the extracting features further comprises generating metadata of the image features and the generating the classification further comprises the rule processing engine to process the metadata of the image features.

13. The product of claim 11, wherein the device is one of a quantum well infrared photodetector or an indium antimonide (InSb) detector.

14. The product of claim 11, wherein the device is a long wavelength digital camera having a sensitivity to radiation emitted between 8 and 15 micrometers.

15. The product of claim 11, wherein the receiving, the extracting, the generating, and the displaying the data are performed in approximately real time.

16. The product of claim 11, wherein the features of the image are at a distance of 5 to 100 meters from the device.
